(19) United States
(12) Patent Application Publication
(10) Pub. No.: US 2003/0021667 A1
(43) Pub. Date: Jan. 30, 2003

(54) Forklift attchment for carrying a barrel and dumping the contents thereof

(76) Inventor: Olen Spincer Harrell, Flora, MS (US)

Correspondence Address: ROBERT M. MASON, MASON & PETRUZZI, SUITE 402W, 13601 PRESTON ROAD, DALLAS, TX, 75240, US

(21) Appl. No.: 09/917,424

(22) Filed: Jul. 27, 2001

(51) Int. Cl. B66F 1/00

(52) U.S. Cl. 414/607

(57) ABSTRACT

A forklift attachment for carrying and dumping a barrel includes a first and a second hollow tube, each for insertion of forklift tines. In addition, first and second curved barrel-holding devices are attached by a hinge to the hollow tubes. The first and second barrel holding devices are each able to swing up and down and pivotally swivel about a point in the hinge. A latch has a first position to keep the barrel holding devices fixed and a second position allowing the barrel holding devices to pivotally swivel. In this manner, a barrel may be held between the forklift tines, easily moved, and its contents dumped out.

### CROSS REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

This invention relates generally to the field of barrel carrying devices, and more particularly to a forklift attachment that can grip, carry, and dump the contents of a barrel.

Barrels come in a variety of sizes and shapes, though a standard barrel is a 55-gallon drum, circular in cross- section, and of a standard curvature. Further, standard drums often have ribs circumferentially spaced along the edge, though not all do. Such barrels have a variety of uses, and one such use is for storage of any of a variety of contents until disposal. Because the barrel is relatively large, when filled, the barrel can be quite heavy and difficult to move. Once moved to a location for disposal, the filled barrel can be quite difficult to lift and dump into a standard dumpster, or a like disposal container, or otherwise.

U.S. Pat. No. 5,366,339 to D. Gould discloses a lifting device for barrels adapted to fit on the tines of a forklift, as is U.S. Pat. No. 4,318,661 to Helm. While a variety of methods and equipment are available for grasping and moving barrel drums, there is not at this time safe, efficient and easy equipment or method for dumping the barrel drum contents.

### BRIEF SUMMARY OF THE INVENTION

An object of the invention is to provide an improved forklift attachment for carrying and dumping a barrel having contents therein.

Another object of the present invention is to provide for the dumping of barrel contents while maintaining control of the barrel.

In accordance with a preferred embodiment of the present invention, a forklift attachment for carrying and dumping a barrel comprises first and second tine attachments for attaching to first and second forklift tines, respectively; first and second barrel holding devices hingedly attached to the first and second tine attachments, respectively; the first and second barrel holding devices each able to swing up and down and pivotally swivel about a point in the hinge; a latch having a first position to keep the barrel holding devices fixed and a second position allowing the barrel holding devices to pivotally swivel.

Other objects and advantages will become apparent from the following descriptions, taken in connection with the accompanying drawings, wherein, by way of illustration and example, an embodiment of the present invention is disclosed.

### BRIEF DESCRIPTION OF THE SEVERAL DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a plan view of the forklift attachment for carrying and dumping a barrel in accordance with a preferred embodiment of the present invention.

FIG. 2 is a perspective view of the hinge as used in the forklift attachment for carrying and dumping a barrel of FIG. 1.

FIG. 3 is a perspective view of the forklift attachment of FIG. 1 being fit over a barrel.

FIG. 4 is a perspective view of the forklift attachment of FIG. 1 after the latch is released showing the barrel dumped.

FIG. 5 is a perspective view of the forklift attachment of FIG. 1 while returning the barrel to its upright position.

### DETAILED DESCRIPTION OF THE PREFERRED EMBODIMENTS

Detailed descriptions of the preferred embodiments are provided herein. It is to be understood, however, that the present invention may be embodied in various forms. Various aspects of the invention may be inverted, or changed in reference to specific part shape and detail, part location, or part composition. Therefore, specific details disclosed herein are not to be interpreted as limiting, but rather as a basis for the claims and as a representative basis for teaching one skilled in the art to employ the present invention in virtually any appropriately detailed system, structure or manner.

Turning now to the drawings, FIG. 1 is a plan view of the forklift attachment 10 for carrying and dumping a barrel in accordance with a preferred embodiment of the present invention. Hollow tubes 11, 13 are shown and are adapted to fit with the tines of a standard forklift. Hollow tubes 11, 13 are shown attached with crossbar 15 to make fitting forklift attachment 10 easier, as well as provide structural support for attachment 10 while in use.

Connected at the far end of tubes 11, 13 are hinges 17, 19, one at each of hollow tubes 11, 13 connecting barrel-holding devices 22, 24. It will be appreciated that hollow tubes 11, 13 are hollow at the near end to accommodate forklift tines, though may have a different shape, cross-section or other structure at the far end. One hinge will be described in detail, though it will be appreciated that the other hinge can be similarly constructed, taking into account the mirror image considerations from one side to the opposite, understanding that the barrel will be placed there between. Hinge 17 has fixed knuckles 26, 28 at the distal ends thereof, and movable knuckle 30 there between. In this configuration, hinge 17 allows barrel-holding device 22 to swivel up and down, but is prevented from swiveling downward below hollow tube 11. In this way, forklift attachment 10 can be lifted over the top of a barrel supported from the underside by, for example, the ground, or other supporting structure, and lowered along the edge of the barrel. When being lowered, barrel holding devices 22, 24 swivel upwards to allow forklift attachment 10 to be lowered without obstruction. As will be appreciated, however, when forklift attachment 10 is raised with respect to the barrel, barrel-holding devices 22, 24 will clamp onto the barrel and hold the barrel. After lifting the barrel off the support structure, the forklift can be raised and lowered, while coincidentally raising and lowering the barrel.

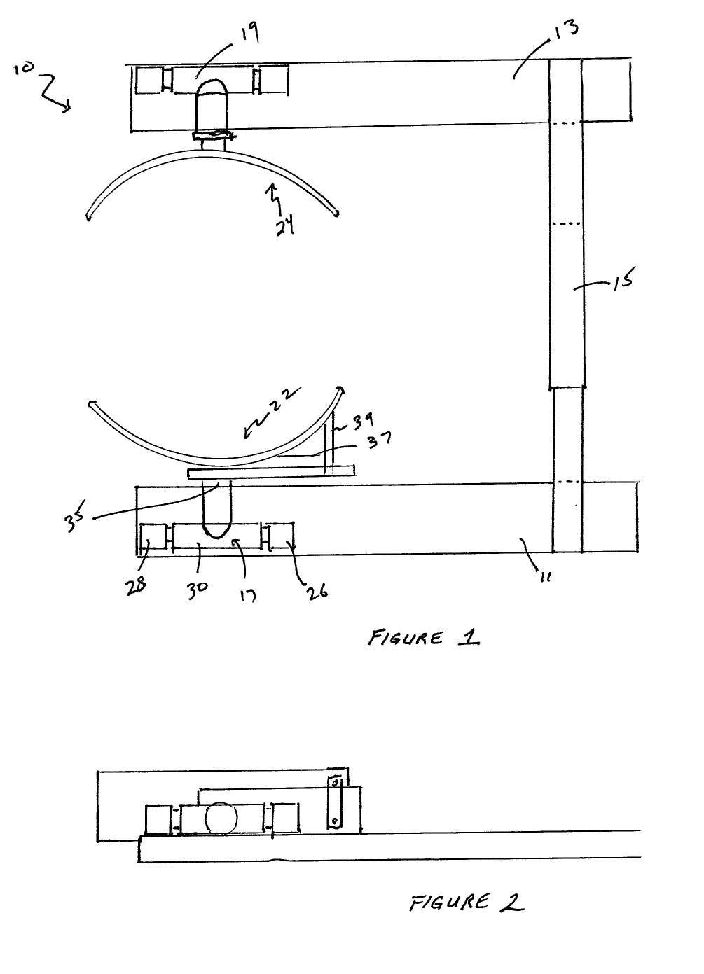

FIG. 2 is a perspective view of hinge 17 as used in forklift attachment 10 for carrying and dumping a barrel. In more detail, hinge 17 includes pivot connection 35 allowing barrel holding device 22 to pivotally swivel about pivot connection 35. Hinge 17 has two positions. A first position wherein barrel-holding device 22 is fixed, allowing no swivel action. A second position allows easily swivel action about pivot connection 35. In this way, a barrel may be fixedly held in relation to the forklift tines for moving, and be rotated in relation to the forklift tines for dumping the barrel contents, as is described in detail below.

To move hinge 17 from the fixed position to the swivel position, latch 37 is illustrated in FIG. 2. Latch 17 acts in connection with rod 39 on barrel holding device 22, so that when rod 39 is held in place by latch 37, hinge 17 is in a fixed position. When latch 37 is moved so as to release rod 39, barrel-holding device 24 is able to swivel about connection 35. Latch 37 may be of a variety of designs and may be activated from the rod holding position to the rod-releasing position by mechanical, electrical, hydraulic, remote, or other ways. In addition, a motor may be mounted to control the speed at which the barrel may turn for dumping the contents.

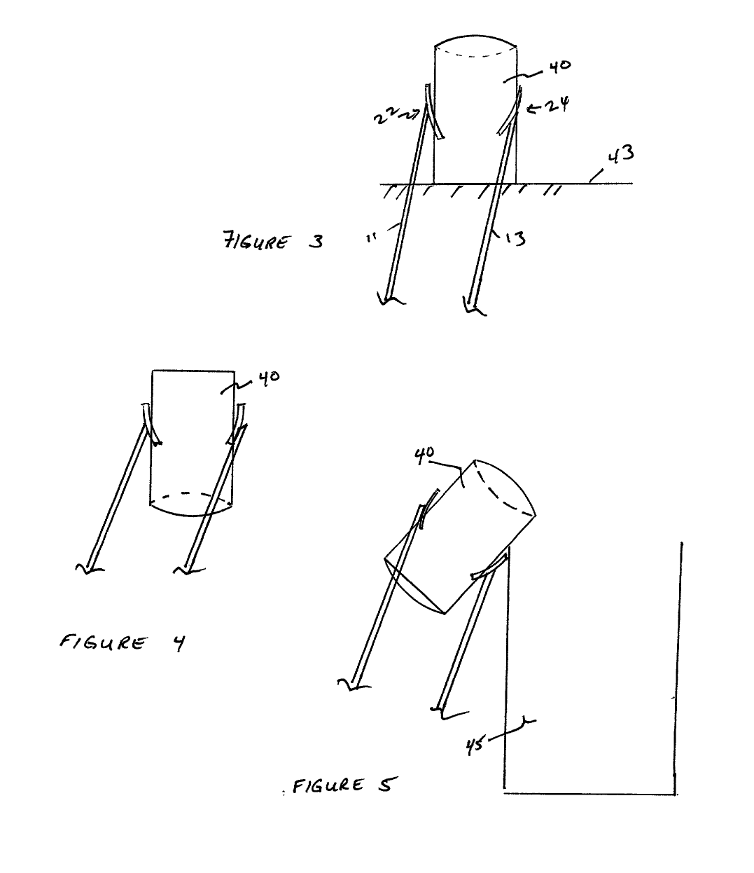

FIG. 3 is a perspective view of forklift attachment 10 being fit over barrel 40. Barrel 40 is shown on ground 43 while forklift attachment 10 is being lowered over barrel 40. As is illustrated, hinge 17 allows barrel-holding device 22 to swing upwards as barrel-holding device 22 is moved downwards relative to barrel 40. At the desired location on barrel 40, barrel-holding device 22 is moved upwards in relation to barrel 40. In such an operation, barrel-holding device 22, in connection with barrel-holding device 24, swing downwards to hold barrel 40 there between. When forklift ties are moved further upwards, forklift attachment 10 lifts barrel 40 off the ground and barrel 40 may be easily carried from one location to another.

FIG. 4 is a perspective view of forklift attachment 10 after latch 37 releases rod 39 showing the barrel dumped. After rod 39 is released from latch 37, barrel-holding devices 22, 24 pivotally swivel about pivot connection 35. So that barrel 40 turns upside-down, barrel-holding devices 22, 24 should be below the center of gravity of barrel 40 and its contents. To direct barrel 40 from swiveling towards or away from a forklift, forklift tines may be tilted upward or downwards as is conventional in forklift design.

FIG. 5 is a perspective view of forklift attachment 10 while returning barrel 40 to its upright position. Forklift may be manipulated to place barrel 40 edge along the sides of container 45 to bring barrel to its upright position while setting barrel 40 on the ground. After barrel 40 is set on ground 43, lowering forklift tines will again swing barrel-holding devices 22, 24 upward, releasing barrel 40 and allowing the easy removal of barrel 40.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A forklift attachment for carrying and dumping a barrel comprising:
first and second tine attachments for attaching to first and second forklift tines, respectively;
first and second barrel holding devices hingedly attached to the first and second tine attachments, respectively;
the first and second barrel holding devices each able to swing up and down and pivotally swivel about a point in the hinge;
a latch having a first position to keep the barrel holding devices fixed and a second position allowing the barrel holding devices to pivotally swivel.
